(19) United States
(12) Patent Application Publication
(10) Pub. No.: US 2015/0248722 A1
(43) Pub. Date: Sep. 3, 2015

(54) WEB BASED INTERACTIVE MULTIMEDIA SYSTEM

(71) Applicant: Swell, Inc., New York, NY (US)

(72) Inventors: Tarik Malak, New York, NY (US); Timothy Patrick Douglas, New York, NY (US); Nicholas Charles Esposito, Hoboken, NJ (US); Eamon Matthew Monaghan, Jersey City, NJ (US); Paul Gladstone, New York, NY (US)

(21) Appl. No.: 14/637,107

(22) Filed: Mar. 3, 2015

Related U.S. Application Data
(60) Provisional application No. 61/966,870, filed on Mar. 3, 2014.

(51) Int. Cl. G06Q 30/06; G06F 3/0481; G06F 3/0484; G06F 17/30

(52) U.S. Cl. CPC G06Q 30/0641; G06F 17/30893; G06F 3/04817; G06F 3/04847

(57) ABSTRACT

A web based interactive multimedia platform that provides web based commercial activity is provided. The web based interactive multimedia platform includes a core structure and one or more modules installed on top of the core structure and interconnected to each other and the core structure via a common interface. The core structure facilitates the playing of video within the platform on a web browser page, and the displaying other media within the platform on a web browser page platform. The core structure is to be embedded within the code base of a web browser having built-in multimedia processes. The one or more modules provide additional functionality, interactivity, and/or shoppability to enhance user shopping experience.

### CROSS-REFERENCE TO RELATED APPLICATIONS

This application claims priority to co-pending U.S. Provisional Application No. 61/966,870, filed on Mar. 3, 2014, entitled “Web Based Interactive Video System” which is incorporated herein in its entirety by reference.

### BACKGROUND

1. Field

The present disclosure relates generally to the field of electronic commerce and information distribution and, more specifically, to a web-based interactive multimedia system using interactive video and/or other media to promote the sale of products or services, or to promote the distribution of information.

2. Description of the Related Art

Vector graphics, animations, games and rich Internet applications are typically viewed via a web browser using plug-in technology, known as Flash technology. Flash technology is frequently used for multimedia functions, such as adding streamed video and/or audio players, and adding advertisement and interactive multimedia content to web pages. A browser plug-in is not native to any web browser. A browser plug-in is a software component that adds a specific feature to the web browser. In the case of Flash technology, the plug-in adds the above described multimedia features to a web browser. The trouble with plug-ins is that they are not native to the web browser code base so they need to be added to the web browser. Installing plug-ins can cause a number of problems for users, such as installation and operational problems. Moreover, with the evolution of hyper-text markup language (HTML) to its most recent version, HTML5, new syntactic features were added to the HTML5 code base allowing software developers to incorporate certain multimedia functionality, formerly provided by browser plug-ins, directly into the web browser code base. Such newly added functionality includes new video, audio and canvas elements. As a result, Flash technology is now being deprecated.

However, HTML5 does not provide for robust web-based multimedia functionality, such as interactive video content on the web. The system according to the present disclosure improves upon web browsers with built-in video, audio and canvas elements, such as HTML5 based web browsers, with a new platform for providing interactive multimedia (e.g., video and/or audio) content on the web.

### SUMMARY

The system according to the present disclosure relates to web based interactive multimedia (e.g., video, audio, still images, other content, and any combinations thereof) used, for example, to provide web based commercials to market and/or advertise products. More specifically, the system is an extensible module-based interactive video platform for the web (i.e., the Internet). The system has a core structure, which is also referred to as the Base Player module, and added functional modules interconnected to each other and the Base Player module via common interfaces. The Base Player module allows for the playing of video and other media within the system, and is capable of accepting one or more modules providing additional functionality, not provided for with HTML5, that are installed on top of the Base Player module. The additional modules provide or enable additional functionality, interactivity, and/or shoppability to enhance the user experience on the web.

The Base Player module when executed performs core functions, such as display streaming video and audio and collecting information about the streaming video and audio, and allows other modules to obtain information about multimedia playing within the Base Player module. For example, the Base Player module can provide the other modules information about the state of a video playing. The Base Player module also allows other modules to modify or supplement the playback of the video and audio being streamed by the Base Player module. The Base Player module abstracts away direct interaction with an underlying video and/or audio file, so that additional functionality can be added via the additional modules. For example, a Controls module can be overlaid onto the Base Player module code base to enable functionality by which the Base Player module displays controls over the video while the video is playing that can be activated by the user. Examples of such controls include a play/pause button, a volume control button or slide, a mute button, and a multi-section (e.g., a three section) time bar that indicates different information about the video playing, such as the total length of the video, the played length of video, and the amount of buffered video available after the current time in the video. A Carousel module can be overlaid onto the Base Player module code base to enable functionality by which the Base Player module enables functionality that creates a moving (e.g., rotating) carousel of objects, such as consumer products, preferably below or beside a video playing within the system. Alternatively, the carousel can be placed to the side of the video playing within the system in the event that a wider presentation is preferred to a taller one.

Additional modules can be added to the system to provide a more enhanced user experience. Examples of such modules include: A Dynamic Speed module that changes the playback rate of a video playing in the system in response to a trigger action. A Split-screen module that creates an interactive “split-screen” effect over a video playing in the system. A Multiple Cameras module enables a user to select one of multiple camera angles of the same subject in a video playing within the system. A Multiple Grades module enables the system to show any one of multiple color grades of a video playing within the system. An Interactive module can be configured to create various user experiences, such as a choose-your-own-adventure experience. A Reveal Box module that overlays a video with a “reveal box”, i.e., a small area in which additional video content is displayed, over a main video playing within the system. An Interstitial Video module that upon a user action may pauses the main video that the system is playing, and instead shows one or more “interstitial” videos. When the “interstitial” video ends, the user is returned to the video that was originally playing. An In-Platform Image and Video Filtering module that filters a video playing in the system or images shown by the system to create visual effects which are seamlessly overlaid on the video playing. A Zoom Box module where an area of a video playing within the system may be zoomed in upon. These modules can be used for a particular user experience or one or more or all of the modules described in the present application may be used depending upon the desired user experience.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a block diagram of an exemplary embodiment of the system according to the present disclosure;

FIG. 2 is a block representation of an exemplary embodiment of a masked video stack according to the present disclosure;

FIG. 3 is a block representation of an exemplary embodiment of the output of a Controls module according to the present disclosure;

FIG. 4 is a flow diagram of the process for operating controls associated with the Controls module;

FIG. 5 is a block representation of an exemplary embodiment of the output of a Carousel module according to the present application;

FIG. 6 is a flow diagram of an exemplary embodiment of the process for operating a carousel associated with the Carousel module;

FIG. 7 is a block representation of an exemplary embodiment of the output of a Split-screen module according to the present disclosure;

FIG. 8 is a flow diagram of an exemplary embodiment of the process for generating a split-screen effect;

FIG. 9 is a flow diagram of an exemplary embodiment of the process for representing a subject in a video at multiple angles;

FIG. 10 is a flow diagram of an exemplary embodiment of the process for downloading social media content for use by other modules within the system;

FIG. 11 is a flow diagram of an exemplary embodiment of the process for downloading location and map information of a user for use by other modules within the system;

FIG. 12, is a flow diagram of an exemplary embodiment of the process for pausing a main video and playing an interstitial video;

FIG. 13 is a block representation of an exemplary embodiment of the output of a Reveal module according to the present disclosure;

FIG. 14 is a flow diagram of an exemplary embodiment of the process for generating a reveal effect;

FIG. 15 is a block representation of an exemplary embodiment of the output of a Zoom module according to the present disclosure;

FIG. 16 is a flow diagram of an exemplary embodiment of the process for generating a zoom effect;

FIG. 17 is a flow diagram of an exemplary embodiment of the process for dynamically changing the speed of a video playing within the system;

FIG. 18 is a flow diagram of an exemplary embodiment of the process for filtering video or images according to the present disclosure;

FIG. 19 is a block diagram of an exemplary embodiment of an networked based computing environment for use with the web based interactive multimedia system according to the present disclosure; and

FIG. 20 block diagram of a computing environment for use with the web based interactive multimedia system according to the present disclosure.

### DETAILED DESCRIPTION

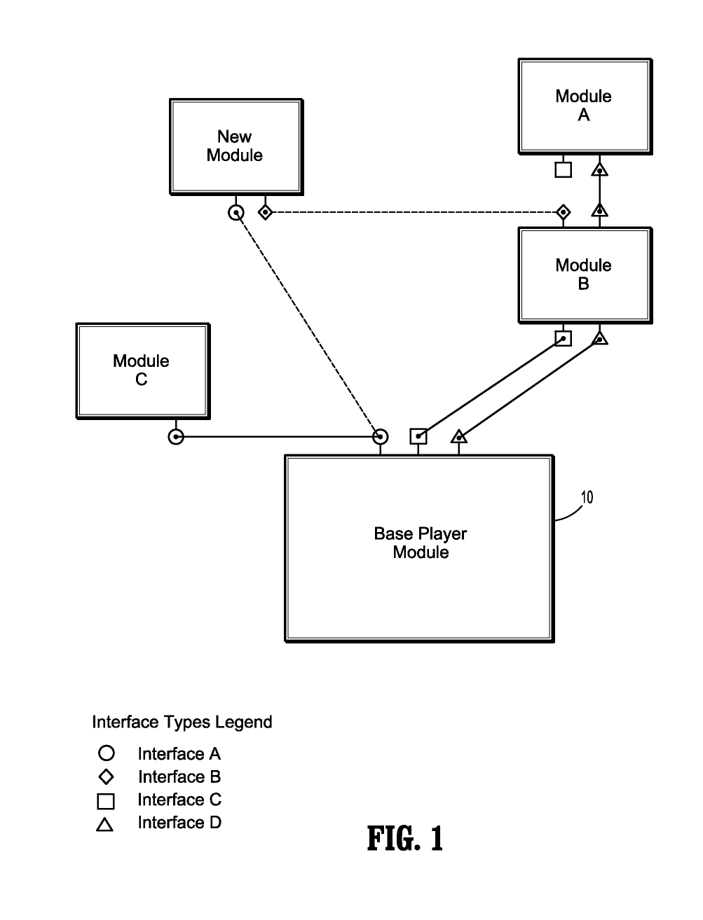

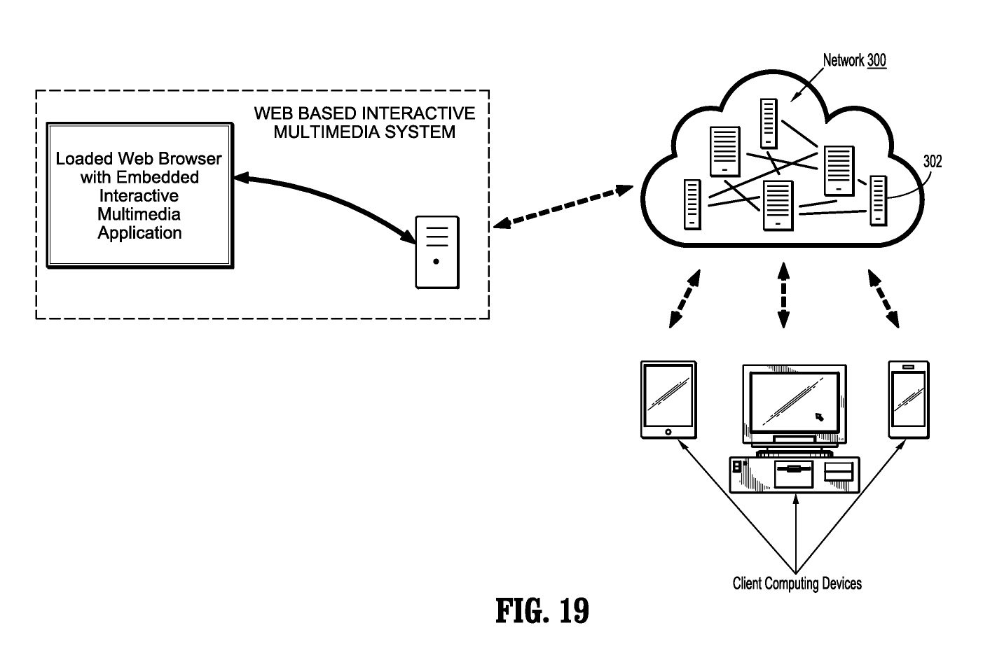

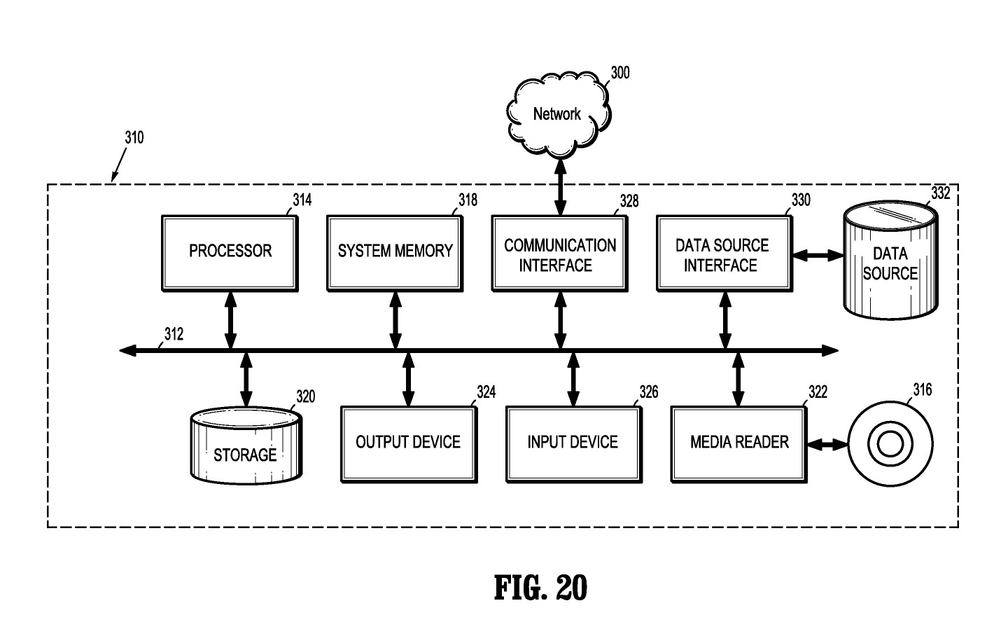

The web based interactive multimedia system according to the present disclosure, shown in FIG. 1, which may also be referred to herein as the “platform”, is configured to run in an HTML5 based web browser without the need for the installation of plug-in technology. The platform is an extensible module-based interactive multimedia platform for the web. The platform according to the present disclosure adds to and improves the audio, video, and canvas elements defined in the HTML5 specification to enable user interaction with the platform in ways that HTML5 cannot achieve stand-alone. The platform is capable of operating with all HTML5 based or compatible web browsers and environments, such as Google® Chrome, Mozilla Firefox, Apple® Safari, and Microsoft® Internet Explorer (version 9 and above). The platform is also capable of operating on mobile browsers, such as Apple® Safari Mobile and Google® Chrome for mobile devices. The platform is embedded in a web page of a party implementing the platform, for example a vendor of products, and can be downloaded into a computing environment, such as the computing environments of FIGS. 19 and 20, or stored on a storage medium, such as a disk, system memory or a USB drive, or the platform may be transferred to a party implementing the platform via an efile or other known technique.

As noted above and referring to FIG. 1, the system according to the present disclosure is an extensible module-based interactive multimedia platform for the web. The system has a core structure 10, which is also referred to as the Base Player module, and one or more additional modules (e.g., modules A-C) installed on top of the Base Player module code base. Generally, the Base Player module 10 allows for the playing of video and/or audio within the system, and is capable of accepting one or more additional modules (described below) that enable new functionality, interactivity, and/or shoppability to enhance the user experience. Shoppability is generally defined herein as functionality by which audio, video, and/or imagery relating to purchasable products may be combined allowing users to browse and/or buy purchasable products outside of the environment where the purchasable products exist online (i.e., shopping) within the system of the present disclosure, rather than in a vendor web store.

The Base Player module 10 and additional modules (e.g., Module A, Module B and Module C) communicate with each other via a common interface structure. The communication interface structure allows software for new modules to be written with minimal effort and integrated to the platform with exponentially smaller effort than if one were to write code to enable a single module's functionality from scratch. Once written, modules communicate with one another through the common interface to allow for seamless integration. Each additional module adds a layer of complexity to the platform, allowing for increased functionality across the entire platform.

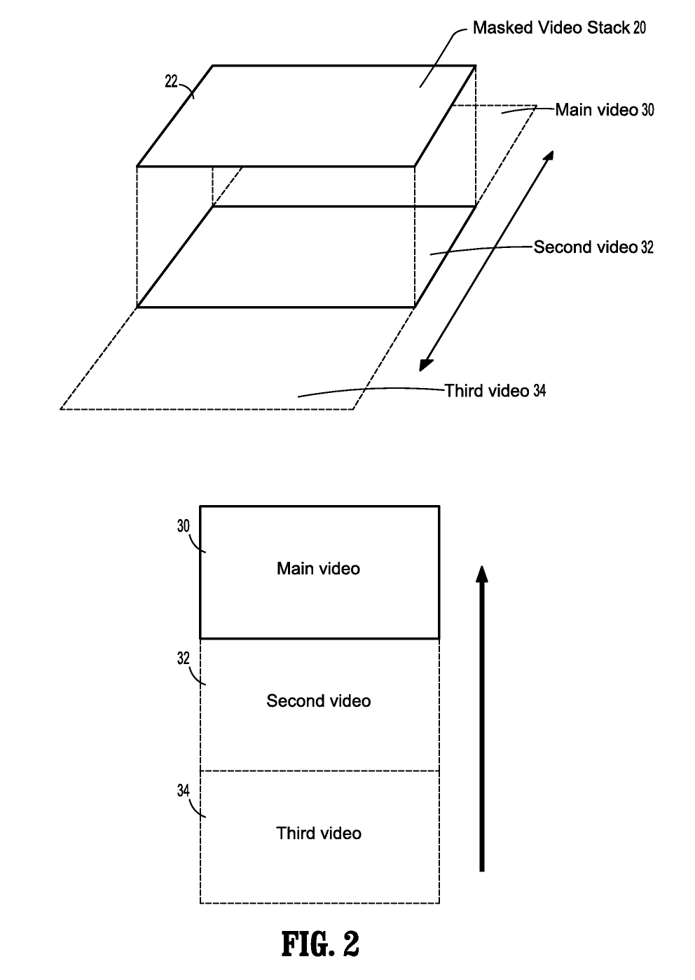

The Base Player module provides core functions for the platform. For example, the Base Player module controls the loading and playing videos and other media in a web browser window. Referring to FIG. 2, the Base Player module contains a masked video stack 20 that contains for display one video element at any given time and any number of additional video elements, that may or may not be used by the additional modules to enable more interactivity. In the embodiment shown in FIG. 2, the masked video stack 20 comprises a container 22 and a video file comprising one or more videos.

The container 22 is typically sized so as to fit one video of a video file within its boundaries. The container 22 is able to hold objects larger than itself (typical for any web page element such as an HTML 5 element). The video file is typically larger than the container 22, in width and/or height, so as to fit one video from the video file within the container's boundaries. In the embodiment shown in FIG. 2, the video file contains a main video 30, a second video 32 and a third video 34. The multiple videos within the video file are individual videos positioned adjacent to one another so as to make a “stack” of videos. The video file has one audio track that is shared by the one or more videos. When the video file is placed within the container 22 only a portion of the video file is visible at any time, since the video file is typically larger than the container 22. Preferably, the video file is positioned within the container 22 so that one full video, e.g., main video 30 or second video 32 or third video 33, is visible by a user at any one time, with other videos in the masked video stack outside the boundaries of the container 22 and invisible to the user.

The Base Player module is also capable of placing objects within the container 22. Areas of any object placed inside the container 22 that fall outside the container's boundaries are masked and not visible to users.

Depending upon an intended user experience, a party implementing the platform to promote the sale of purchasable products or services, or to promote the distribution of information about purchasable products or services, may configure the platform for such purposes. When configuring the platform to interact with one or more additional modules via the common interface, the one or more modules are referenced in the Base Player module's root file for that configuration. The one or more modules can then be activated by calling each of the one or more module's individual initialization process from within the Base Player module's initialization process. That is, the Base Player module initiates running “setup” of the code for each of the one or modules within the existing configuration, at the same time as running “setup” for the Base Player module.

The Base Player module includes processes in the form of software that when executed by the web browser allows one or more additional modules to get information about the state of a video playing (such as, current time, playback rate, and actual pixel information), as well as allows other modules to modify playback of the video (such as current time and playback rate). The Base Player module's processes abstract away direct interaction with an underlying video file, so that additional functionality can be added to the web browser via other modules.

Examples of the Base Player module's processes include:
a. play, pause, and mute processes that can make one or more calls to the web browser video element (e.g., HTML5 video elements) instructing the web browser video element to play, pause, or mute the source multimedia material (e.g., a video file) loaded within the platform.
b. a current time process can make one or more calls to the web browser video element (e.g., HTML5 video elements) requesting the number of seconds into playback of the source multimedia material (e.g., the main video 30, the second video 32 or the third video 34) loaded into the platform has passed.
c. a time-to-set process can make one or more calls to the web browser video element (e.g., HTML5 video elements) passing a time into the process that directly sets the elapsed time (e.g., in seconds) of the video (e.g., the main video 30, the second video 32 or the third video 34) playing within the platform.
d. a buffer process can make one or more calls to the web browser video element (e.g., HTML5 video elements) requesting an amount of time (e.g., in seconds) available within the video buffer, which is the time the video (e.g., the main video 30 or the second video 32 or the third video 34) is able to play but has not reached yet.
e. a load video process that determines the correct format of the video file to load into the web browser video element (e.g., HTML5 video elements), and then loads the video file of the correct format into the web browser video element.
f. a resize process can make one or more calls to the Base Player itself to determine the maximum possible size to display a video (e.g., the main video 30, the second video 32 or the third video 34) within the platform.
g. set play event, set pause event, and set end event broadcast processes can be used to enable behavior associated with the multimedia content, such as a video playing or an image displayed, such as changing within the platform which occurs due to the web browser video element (e.g., HTML5 video elements) beginning playback, pausing playback, or ending playback. Examples of the behavior associated with the multimedia content include changing the speed of the video or changing the volume of the audio.

For example, the platform could be configured to include additional modules that enable dynamic speed (e.g., slow-motion) video playback while placing a shoppable carousel beneath the playing video, by installing two modules on top of the platform. One additional module would be configured to provide the dynamic video and/or audio speed function (e.g., the slow-motion video playback), and the other additional module configured to place the shoppable carousel beneath the playing video.

The Base Player module is responsive to “trigger actions.” A trigger action can be a user input action, such as a mouse hover over a video element, a key press on a keyboard, or a mouse click) or an event which occurs automatically within the Base Player module or any additional module at a predetermined time. Trigger actions are pre-defined via a data file stored in the Base Player module or individual platform modules, or the trigger actions can be installed at the platform level by an individual user.

### Additional Modules and Functionality

### Controls Module

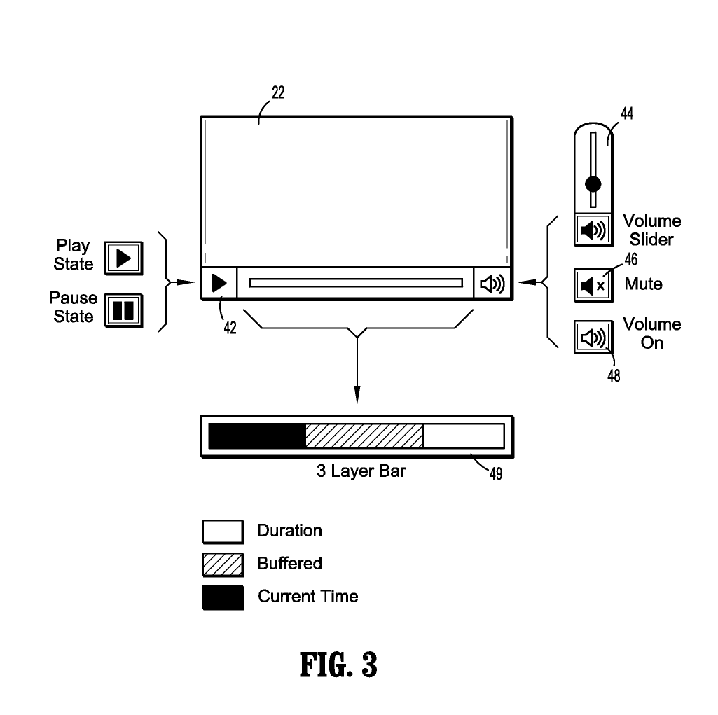

The Controls module 40 enables functionality by which the platform may show controls over the video (e.g., the main video 30, the second video 32 or the third video 34) it is playing. Referring to FIG. 3, examples of such controls include a play/pause button 42, a volume control button or slide 44, a mute button 46, a volume “on” button 48, and a multi-section time bar 49. The multi-section time bar 49, shown in FIG. 3, is a three section time bar that indicates, for example, a total length of video, a played length of video, and an amount of buffered video available after the current time in the video. Upon instantiation of the Controls module, web browser elements, e.g., HTML5 elements, that visually represent these controls are created and added to the masked video stack by the Base Player module so that the controls are exposed to the user, i.e., the controls are visible to the user and functioning.

In an exemplary embodiment of the Controls module operation, approximately 5-10 times per second, the Controls module requests from the Base Player module information on the playback progress of a video playing within and updates the time bar and volume controls. Using the play, pause, or mute processes exposed via the Base Player module, the Controls module can send information to the Base Player module to update the video with the current time of the video, to change the volume of the audio associated with the video playing, or to play or pause the video.

In this exemplary embodiment the controls associated with the Controls module are instantiated at the same time as the instantiation of the platform, i.e., upon a user loading a web page in which the platform is embedded. During instantiation, the Controls module makes one or more calls at small intervals (for example, twice per second) to the Base Player module requesting the current time of the video playing within the platform and its duration. The Base Player module retrieves the current time and duration information from the underlying web browser video element, e.g., the HTML5 video element, and passes the information to the Controls module. The Controls module uses the current time and duration information to update the multi-section time bar 49 positioned for example beneath the playing video, which indicates the video's progress by showing how much time has elapsed versus the total length of the video.

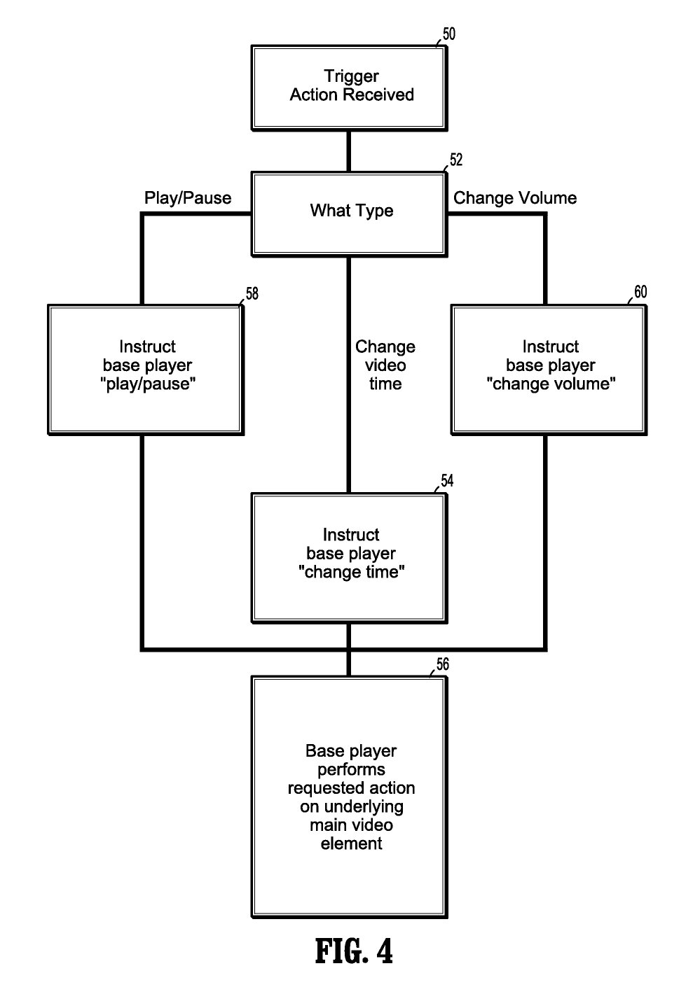

Referring to FIG. 4, if a triggered action occurs on the multi-section time bar 49 (step 50), the approximate location of the triggered action (for example, a mouse click) along the length of the time bar 49 is measured and compared to the total length of the time bar to determine the action type (step 52). The ratio between where on the time bar 49 the trigger action occurred and total length of the time bar values is multiplied by the duration of the video (e.g., main video 30, second video 32 or third video 34) playing within the platform to determine the elapsed time in, for example seconds, that the video's current time should be set to. In other words, where on the time bar 49 should the playing video be fast forwarded to or rewound to. Once the position on the time bar 49 where the video should be moved to is determined, the Controls module 40 then makes one or more calls to the Base Player module requesting that the Base Player module modify the current time of the video playing (step 54). The Base Player module then performs the requested action on the underlying web browser video element to change the time of the video (step 56).

If a triggered action occurs on a section of the Controls module output which represents a “play/pause” button 42 at step 52, the Controls module makes one or more calls to the Base Player module requesting that the Base Player module pause or play the video (step 58). The Base Player module then performs the requested action on the underlying web browser video element, which causes the video to play or pause (step 56).

If a trigger action occurs on a section of the Controls module output which represents a sliding control for volume button 44 or mute button 46 at step 52, the Controls module makes one or more calls to Base Player module requesting that it change the volume of the video (step 60), and the Base Player module performs the requested action on the underlying web browser video element. If the requested action is to change the volume, the web browser video element causes the volume of the audio associated with the video to increase or decrease (step 56). If the requested action is to mute the volume via mute button 46, the web browser video element causes the volume of the audio associated with the video to mute at step 56.

### Carousel Module

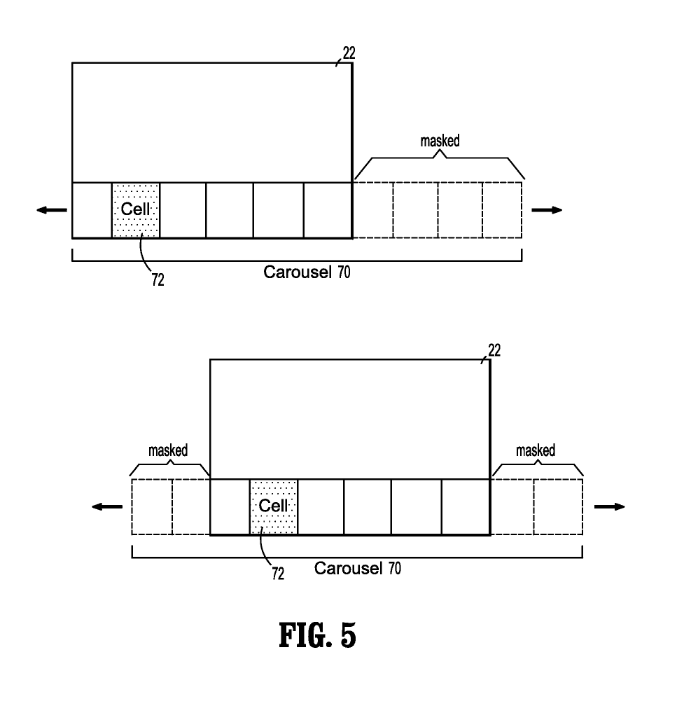

Referring to FIG. 5, the Carousel module enables functionality which creates a moving (e.g., a rotating) carousel 70 of objects, such as products, in cells 72 below a video playing within the platform. The carousel of objects is also referred to herein as the “Carousel”). It should be noted that while the Carousel is shown below the video playing, the Carousel can be positioned anywhere within the container 22. As noted, the Carousel contains cells 72, each of which contains an object. An object may be, for example, an image and in some embodiments “shop now” links that are configured to take users from the platform directly to a web store of a vendor who is selling the product displayed within a particular cell. The images and “shop now” links may represent purchasable products being sold by a vendor or manufacturer, or the images and “shop now” links may represent non-purchasable products.

Preferably, the objects displayed in the cells 72 are associated with representations of the objects visible to users via the container 22. The Carousel retrieves data about images to be rendered in a cell, links, and cue points from a rider data file, stored within the Base Player module, which stores links to hosted images, numerical values for cue points, and links to products in web-stores. Upon initialization, the Carousel reads the data file, downloads appropriate images, and creates a cell for every product referenced in the rider data file. As noted, the rider data file may specify links and images which are not representative of purchasable products, in which case cells are filled with a different sort of data and can be used to provide links to other web pages that may include related content or social media pages. At any given time (e.g., the end of the video), a URL can be created by the Carousel module which can be implemented at the client's (e.g., a party who implements the platform) discretion which contains a collection of the products users interacted with while the video was playing, so that they may be shown in a web page or automatically added to a cart on the client's web store for purchase.

As seen in FIG. 5, the cells 72 of the Carousel 70 below the container 22 are visible to users, and the cells 72 outside the bounds of the container 22 are masked (shown by dashed lines). Thus, as the video progresses in time, the carousel rotates (or appears to rotate) such that new objects in the Carousel cells and visible to users.

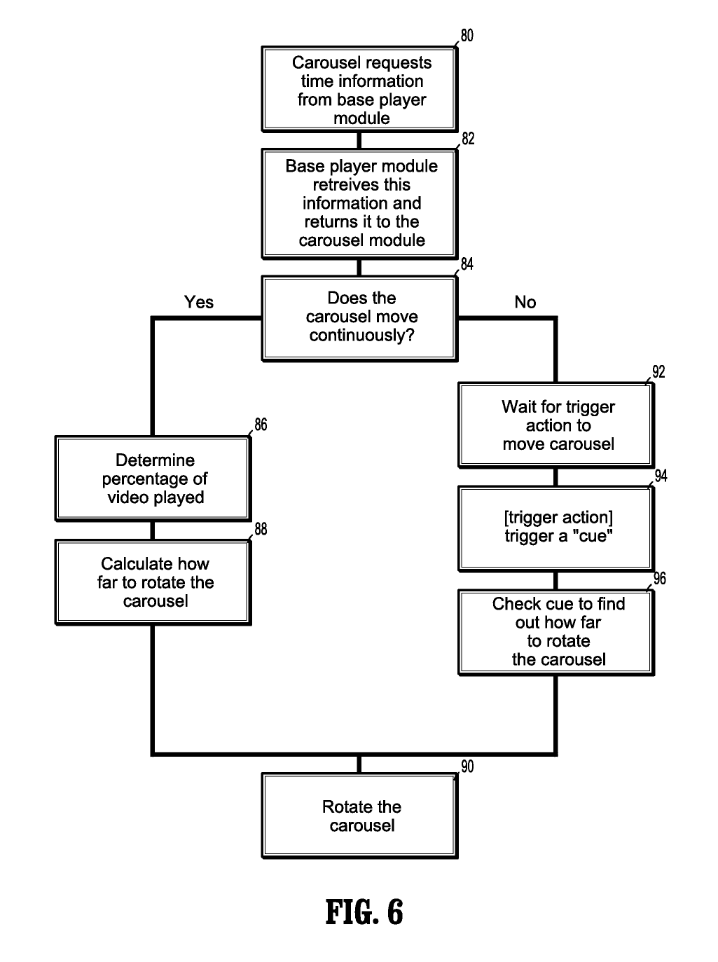

Referring to FIG. 6, a flow diagram of an exemplary embodiment of the process for operating the Carousel associated with the Carousel module is shown. A Carousel associated with the carousel module is instantiated at the same time as the platform, i.e., upon a user loading the web page in which the platform is embedded. Assuming the Carousel contains more cells that can be displayed at one time, the Carousel module can animate the Carousel. In this exemplary embodiment, approximately 5-10 times per second, the Carousel makes calls to the Base Player module requesting current the time information regarding the video playing within the platform (step 80). The time information may be the elapsed time of the video playing in the platform and its duration. The Base Player module retrieves the requested time information from the web browser video element, e.g., the web browser HTML5 video element, and returns the time information to the Carousel module (step 82). The Carousel module then calculates how much of the video's total time has elapsed as a percentage of its duration, and stores this percentage for use in animating the Carousel. The calculated value of the difference between widths of the player and the carousel is then multiplied by the percentage of time elapsed in the playing video to determine how far to rotate the carousel. This method ensures that when the video is finished playing, 100% of the cells will have been seen, since the carousel will have moved 100% of the difference in the widths of the player and carousel.

The Carousel module makes a determination, based on initial calls (or pings) to the Base Player module, whether the Carousel is to move continuously throughout the playing of the video (step 84). If it is determined that the Carousel is to move continuously throughout the video play, the Carousel module determines the percentage of video played (step 86) and uses the percentage to calculate how far to rotate the Carousel (step 88) to continuously move the Carousel at a set speed (e.g. slow speed) from the beginning of the video to the end of the video (step 90). The carousel module determines the required width of the carousel to fit all of its cells, noting that many of the cells may be invisible at any given time. This width is larger than the width of the player, and the difference between the two widths is calculated. The carousel module makes calls at a small interval (for example, twice per second) to the Base Player module requesting the current time of the video playing within the player, and its duration. The Carousel module updates the Carousel's position by rotating an amount equal to the total distance the carousel will need to move over the course of the video, multiplied by the ratio of the current time of the video in seconds divided by its duration in seconds. For example, if the video is 50% over, the carousel's position has rotated 50% of the total amount it will need to rotate to show all or the objects (e.g., products) that the carousel should display.

If at step 84 it is determined that the Carousel is not to move continuously throughout the video play, the Carousel module waits for a cue based trigger action instructing movement of the Carousel (step 92). If the Carousel is configured for ‘cue-based’ motion. The Carousel module creates a list of time-based ‘cues’ for when each cell 72 within the Carousel is supposed to become active during the playback of the video and a reference to which cell owns the cue. Each cue is typically active for a number of seconds, such as 2.5 seconds. It should be noted that the object, e.g., product image, in each cell is shown as slightly transparent to show inactivity and in full focus to show activity.

Upon receiving a trigger action (step 94), the Carousel determines how far to rotate the Carousel (step 96) and sends a request to the Base Player module to move the Carousel (step 90). The distance of rotation of the Carousel is a fixed distance at a point in time defined by a “cue” set at a point within the length of the video's playback, i.e., a cue-based motion.

If the current time of the video is about to pass one of the cue points in the list maintained by the Carousel module (i.e. one of the cue times will be passed before the carousel module requests the video time again from the Base Player module), the Carousel will rotate to show the cell referenced by the cue, and the cell's contained object, e.g., product image, will become opaque to represent that users may interact with it. Conversely, the Carousel Module “hides” objects that have not been referenced by a cue. This allows for timing events in the video to correspond with objects in the carousel becoming active.

### Split-Screen Module

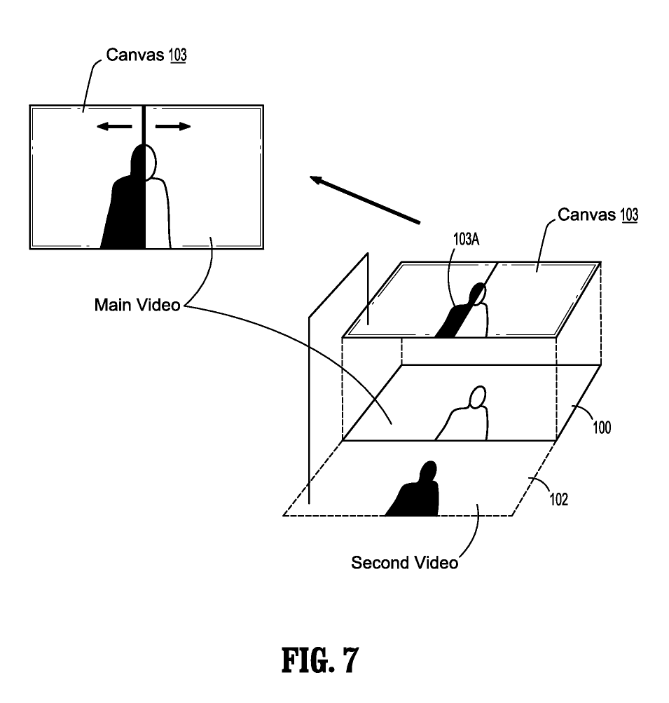

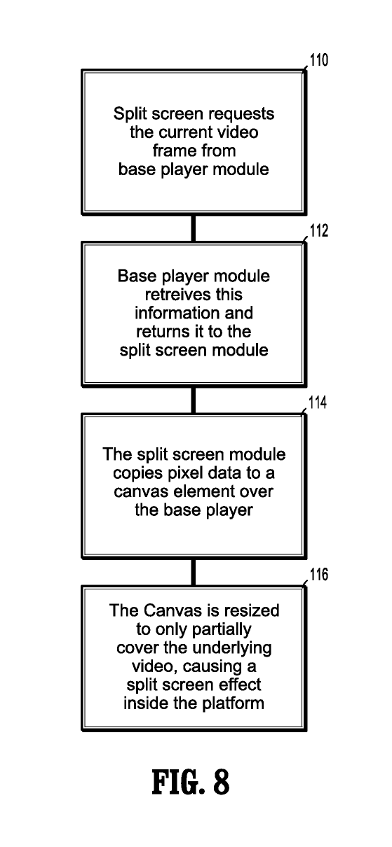

Referring to FIGS. 7 and 8, the Split-screen module enables functionality with which a user can create an interactive “split-screen” effect over a video playing in the platform. To provide a Split-screen effect, a masked video stack of two videos—a main video 100 and a second video 102 are used. In this embodiment the main video is initially visible through the container 22. An HTML canvas 103 is used to render a section of the second video 102A and the canvas 103 is positioned over the container 22 of the masked video stack. The transparent canvas element 103A is placed above the masked video stack, with a height equal to the container's 22 height, and with an arbitrary width between zero and the width of the container 22. The size of the canvas 103 can be altered to a fraction of the total dimensions of the container 22 so that a portion of the main video 100 and a portion of the second video 102, e.g., section 102A, on the canvas 103 are visible by users through the container 22.

The Split-screen module is instantiated at the same time as the platform, i.e., upon a user loading a web page in which the platform is embedded. Once the Split-screen module is instantiated, the Split-screen module makes one or more calls at small intervals, such as 10 calls per second, to the Base Player module requesting access to pixel information from the current frame of the video file, which includes one or more videos, e.g., the main video 100 and second video 102 (step 110). The Base Player module retrieves the pixel information and passes it to the Split-screen module (step 112), which then creates a masked video stack of the two videos—the main video 100 and the second video 102. Initially, the main video 100 is visible through the container 22 and the second video 102 is masked as it is outside the boundary of the container 22. The Split-screen module then creates an HTML canvas element 103 by copying the pixel data of a section of the second video 102A in the masked video stack, and drawing the pixel data of a section 102A onto the canvas 103 (step 114). The canvas 103 is then positioned over the top of the container 22 so as to overlay the canvas 103 over the masked video stack. The canvas 103 is resized so that the canvas element 103A and a portion of the main video 100 is visible to users (step 116). Typically, the canvas 103 is resized by reducing the width of the canvas 103 to a fraction of the total width of the container 22 (e.g., 50 percent). This creates a “split-screen” effect, where an user can see more or less of the second video by modifying the width of the canvas element 103 to cover more or less of the main video 100. It is noted that if a split-screen effect is not desired at the time a video begins playing within the platform, the visual elements which constitute the Split-screen module's functionality can be hidden until a point in the video is reached when the split screen is set to become visible.

### Multiple Cameras Module

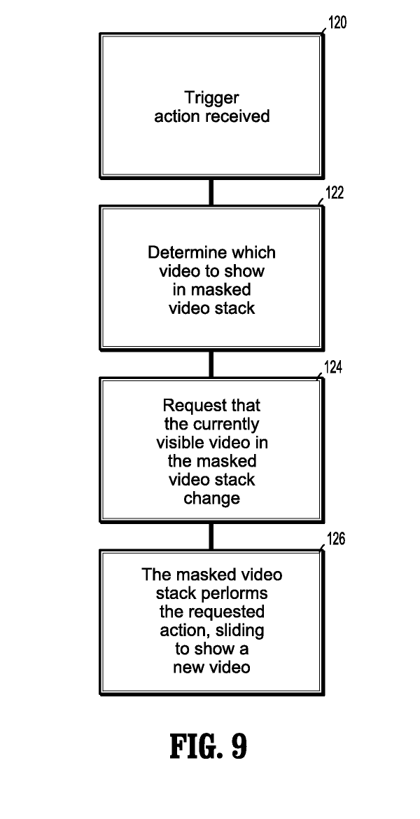

The Multiple Cameras module enables functionality by which the platform may show multiple camera angles of the same subject in a video playing within the platform upon one or more trigger events. Referring to FIGS. 2 and 9, an example of the operation of the Multiple Cameras module will be described. The Multiple Camera module is instantiated at the same time as the platform, i.e., upon a user loading a web page in which the platform is embedded. Once instantiated, the Multiple Camera module is responsive to pre-defined trigger actions while the main video 30 is playing. The trigger actions are pre-defined via a data file stored in the Base Player module or the Multiple Cameras module, or the trigger actions can be actions can be installed at the platform level by an individual user. For example, the trigger actions can be the pressing one or more keys, e.g., the number 1, 2, and/or 3 keys, on keyboard.

A masked video stack that contains a main video 30 and at least one or more videos (e.g., the second video 32, or the third video 34) is created and added to the platform. The masked video stack is then ready for one or more trigger actions to change the currently visible video, which will give the effect of seamlessly switching between multiple cameras. As noted, each video in the masked video stack is a video of the same subject but taken from a different camera angle. For this example, the masked video stack is a three video stack with a main video, a second video and a third video. Initially, the main video is playing and upon a trigger event, the main video is masked and another video (e.g., the second video) is visible. Upon another trigger event, the second video is masked and either the main video or the third video becomes visible.

More particularly, the Multiple Camera module contains a masked video stack which is equal in width and height to the platform itself. Since, in the example above, the masked video stack contains three videos, with only one video is visible to the user through the container 22 at any moment in time. Upon receipt of a trigger action (step 120), the Multiple Camera module makes a call to the Base Player module to shift the video file within the masked video stack, so that a different video, e.g., the second video 32, is visible to the user through the container 22, and the main video 30 is outside the boundary of the container 22 so that it is masked. This action occurs so that it appears instantaneous to the user and creates the multiple camera effect.

### Multiple Grades Module

Referring again to FIGS. 2 and 9, the Multiple Grades module enables functionality by which the platform may show any one of multiple color grades of a video playing within the platform. The Multiple Grades module is instantiated at the same time as the platform, i.e., upon a user loading the web page in which the platform is embedded. Once instantiated, the Multiple Grades module is responsive to pre-defined trigger actions while the main video 30 is playing. The trigger actions are pre-defined via a data file stored in the Multiple Grades module or the Base Player module, or the trigger actions can be installed at the platform level by an individual user. For example, the trigger actions can be the pressing one or more keys, e.g., the number 1, 2, and/or 3 keys, on keyboard.

A masked video stack that contains a main video 30 and at least one more video (e.g., the second video 32 and/or the third video 34) is created and added to the platform. The masked video stack is then ready for one or more trigger actions to change the currently visible video in the container 22, which will give the effect of seeing multiple color grades of the same video. For this example, the masked video stack is a three video stack with a main video 30, a second video 32 with a different color grade than the main video 30, and a third video 34 with a different color grade than the main video and second video. Initially, the main video 30 is playing and visible through the container 22. Upon receipt of a trigger event, the main video 30 is masked (i.e., it is moved outside the boundary of the container 22), and another video (e.g., the second video 32) is made visible within the container 22. Upon another trigger event, e.g., the user pressing the #1 key, the second video 32 would be moved outside the container 22 boundary so it is masked, and either the main video 30 or the third video would become visible in the container 22.

More particularly, the Multiple Grade module contains a masked video stack which is equal in width and height to the platform itself. Since, in the example above, the masked video stack contains three videos, with only one video is visible to the user via the container 22 at any one moment in time. Upon receipt of a trigger action (step 120), the Multiple Grade module determines which video in the masked visible stack is to be made visible through the container 22 in response the trigger action (step 122). For example, if the trigger action is associated with a showing of the second video with a different grade, and that key is pressed, the Multiple grade module determines that second video in the masked visible stack is to be made visible in the container 22. Once the determination is made in step 122, the Multiple grade module makes one or more calls to the Base Player module to shift the video file in the masked video stack (step 124) so that the second video 32 is made visible to the user through the container 22 (step 126). This action occurs so that it appears instantaneous to the user, and creates the multiple grade effect.

### Social Media Connect Module

The Social Media Connect module enables functionality by which a user's social media information may be integrated into the platform experience. For example, the Social Media Connect module can be used to extract information about the user (e.g., a picture or the user's name) on a social media website, such as the user's Facebook account, for combination with a video playing in the platform.

The Social Media Connect module gathers and stores a user's social media information for other modules, such as the Interactive module described below, to use by, for example, combining the user's social media information on an image of a newspaper within a video playing within the platform, or by showing a picture of the user on a magazine page within a video playing within the platform.

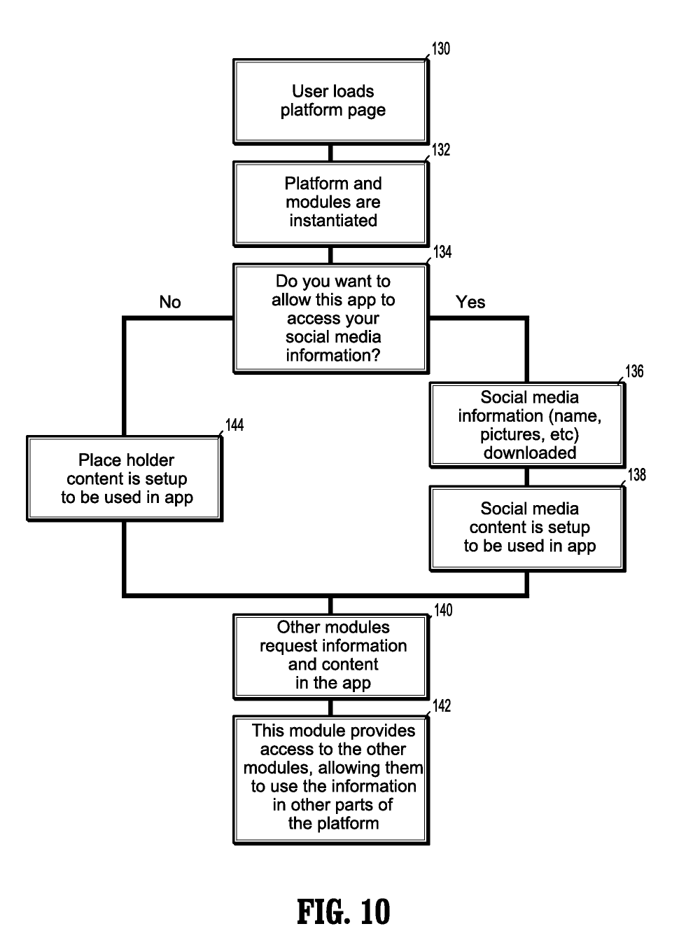

A flow diagram of a process performed by the Social Media Connect module is provided in FIG. 10. A user initially loads the platform webpage into the web browser (step 130). The Social Media Connect module is then instantiated at the same time as the platform, i.e., upon the user loading the web page in which the platform is embedded (step 132). After instantiation, the user is prompted as to whether the user would like to allow the platform to access the user's social media information (step 134). If the user allows the platform to access the user's social media information, the Social Media Connect module encapsulates authorization for and retrieval of assets, such as user information and profile pictures, from one or more social media websites (step 136). Users grant the platform access rights so that the Social Media Connect module can connect to a user's social media accounts in one or more social media websites and extract the user's social media information, such as information identifying the user, information about the user's friends, and pictures the user has posted to the one or more social media websites. Once the user's social media information is retrieved (e.g., downloaded), the Social Media Connect module set's up the user's social media information (step 138), by parsing the data in the Social Media Connect module for key predefined data sets (e.g. username, image files, “friends” names, etc.), for use by other modules in the platform (step 140).

### Geolocation Module

The Geolocation module enables functionality by which a user's location may be integrated into the platform experience. For example, the Geolocation module may display a user's location on a map within a video playing within the platform. The Geolocation module also enables functionality by which the platform may request a user's location within the web browser window in which the platform is playing via an API exposed by the web browser, and use the location information gathered from this request to display visual feedback (e.g., image files, data, etc.) within the platform.

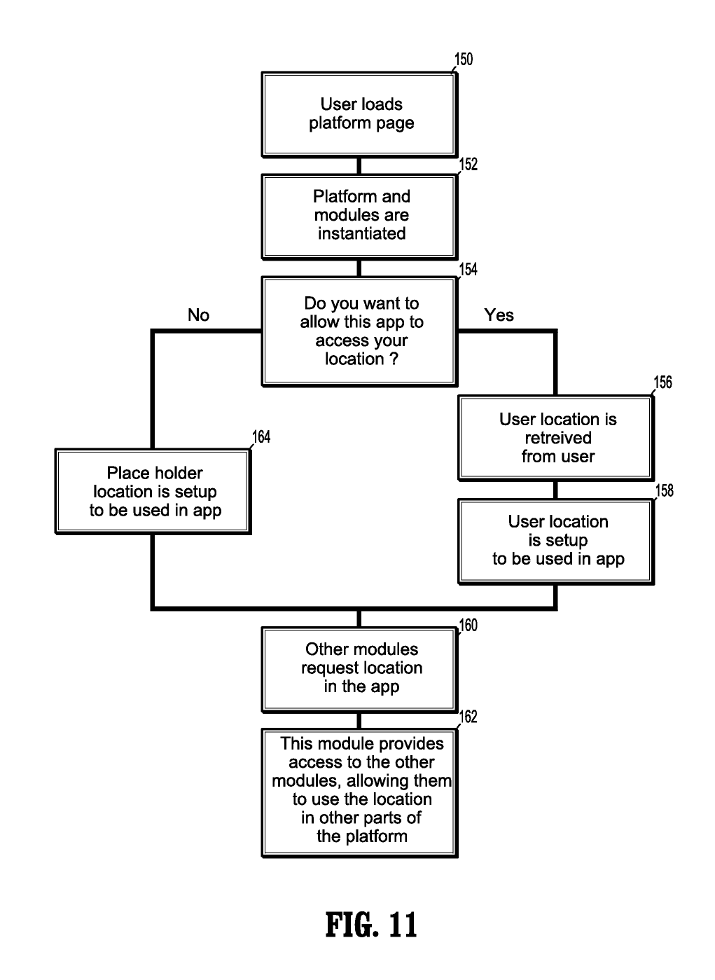

The Geolocation module does not directly place the user's location information inside of the platform. Rather the Geolocation module gathers and stores the user's location information for other modules, such as the Interactive module, to place inside of the platform. A flow diagram of an exemplary embodiment of a Geolocation module process is shown in FIG. 11. A user initially loads the platform webpage into the web browser (step 150). The Geolocation module is then instantiated at the same time as the platform, i.e., upon the user loading the web page in which the platform is embedded (step 152). After instantiation, the user is prompted as to whether the user would like to allow the platform to access the user's location information (step 154). If the user allows the platform to access the user's location information, the Geolocation module encapsulates authorization for and retrieval of the user's location information from geolocation meta data in, for example, the user's mobile phone or based upon the user's IP address from the user's computing device. Users grant the platform access rights so that the Geolocation module can connect to sources tracking the user's location, such as a mobile phone, and retrieve's the user's location information (step 156). Once the user's location information is retrieved (e.g., downloaded), the Geolocation module set's up the user's location information (step 158), by parsing data in the Geolocation Module for key predefined data sets (e.g., longitude, latitude, IP address, etc.) for use by other modules in the platform (step 160).

### Contextual Information Integration Module

The Contextual Information Integration module takes information from the web page on which the platform is embedded so that the web-page information can be used as part of the platform experience. The Contextual Information Integration module takes web page information by scraping desired information from the web page on which the platform is embedded. Examples of web page information scraped include the title of the web page, or the text content of an HTML5 ‘h1’ tag). Data is scrapped by calling for predefined data sets, in the Contextual Information Integration module, and relaying “found” data back to the module. The Contextual Information Integration module gathers and stores web page information for other modules, such as the Interactive module, to place inside of the platform. The Contextual Information Integration module does not directly place scraped information inside of the platform. For example, if the platform were embedded on a beauty blog web page, the Contextual Information Integration module would be able to scrape content from the blog, such as the name of the blog or images from the blog, and set the web page information up for use by other modules within the platform. The other modules could take the web page information and overlay it within a video playing within the platform. Overlays and actions are achieved by a programmed interaction, where the Contextual Information Integration Module calls for specific data sets, (e.g. image files, video files, etc.) to initiate other modules as the main function.

### Interactive Module

The Interactive module enables functionality by which the platform can be used to create various user experiences, such as a choose-your-own-adventure experience. The Interactive module also enables cue-based actions to occur as overlays on the video playing within the platform.

An example of the operation of the Interactive module will be described. Initially, the platform defines a “tree” of individual video files, where each branch in the tree (one for each step in each potential path of the tree) represents options a user can select as part of a choose your own adventure functionality. Each branch within the tree represents a potential path of the tree. Thus, the tree defines an information flow from a first video to all possible final videos, where users may choose from multiple paths to change the video experience, and set their own course through one of the branches in the tree.

When a video file within the platform has finished playing, the Base Player module passes information to the Interactive module declaring that the Base Player module has finished playing the contents of the current video. Upon receipt this information, the Interactive module responds by instructing the Base Player module to present to the user choices as to which video (i.e., which branch in the tree) should be played next, effectively letting users set their path through the video experience. The video playing may also have defined cues which trigger specific actions at moments in a given video's timeline. This is achieved by the Interactive module making a constant call (e.g., once every millisecond) for predefined cues within the Base Player module. Once a cue has been found, the Interactive Module makes a call back to the Base Player module to initiate the desired action. These cues may be unique to each video within the tree, which allows for experiences unique to each video and path chosen by the user. For example, if the Social Media Connect module is part of the user's platform configuration (i.e., the Social Media Connect module is instantiated), a user may be presented with an image of themselves that was retrieved by the Social Media Connect module and set up for use within the platform, as described above, within a picture frame at a moment in a video's timeline where an empty picture frame is on a wall. In this example, the user's image is overlaid on the video at the specific moment in time within the video when an empty picture is to appear through the container 22 in a seamless fashion. This is achieved by the Social Media Connect module making a constant call, e.g. once every millisecond, for predefined cues within the Base Player module. As another example, if the Geolocation module is part of the user's platform configuration (i.e., the Geolocation module is instantiated), a user may see their location on a map displayed in real time on a video playing within the platform. As another example, if the Contextual Information Integration module (described below) is part of the user's platform configuration (i.e., the Contextual Information Integration module is instantiated), a user may see a headline from the day's news playing in a video playing within the platform.

### Interstitial Video Module

The Interstitial Video module enables functionality by which a trigger action may pause the video that the platform is playing, and instead show one or more “interstitial” videos. When an “interstitial” video ends, the user is returned to the video that was originally playing.

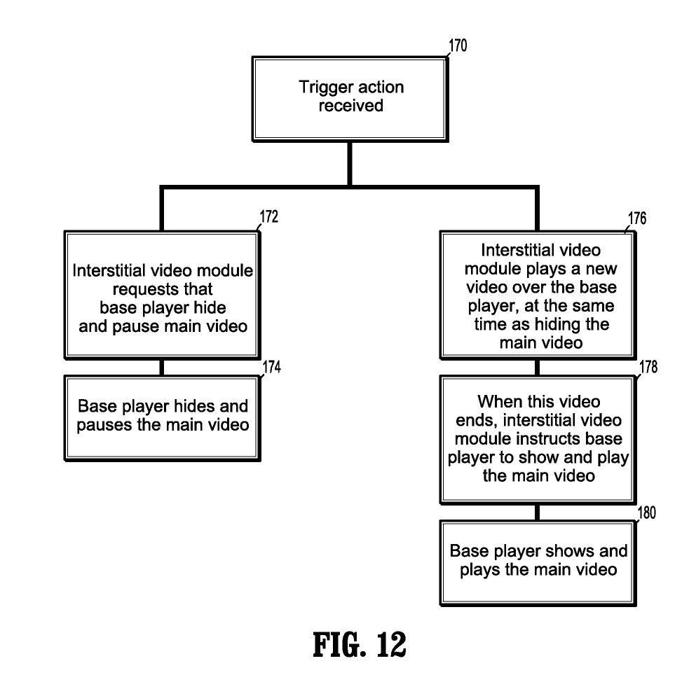

Referring to FIG. 12, an exemplary flow diagram of the operation of the Interstitial Video module is provided. The Interstitial Video module is instantiated at the same time as the platform, i.e., upon a user loading the web page in which the platform is embedded. The Interstitial Video module includes one or more, based on predefined data sets in the Base Player module, additional video elements within the platform, which are hidden and invisible to the user. Once instantiated, the Interstitial Video module is responsive to pre-defined trigger actions while a video, e.g., the main video 30, is playing. The trigger actions are pre-defined via a data file stored in Interstitial Video module or the Base Player module, or the trigger actions can be installed at the platform level by an individual user. For example, the trigger actions can be the pressing one or more keys, e.g., the number 1, 2, and/or 3 keys, on keyboard.

Initially, the multiple video elements are loaded into the masked video stack by the Base Player module and hidden within the platform, except for the main video 30 which is visible through the container 22. Upon receiving a trigger action (step 170), such as a keyboard stroke, or a series of keystrokes pressed in order or an event, the Interstitial Video module makes one or more calls to the Base Player module to pause and then hide (or mask) the main video 30 playing in the platform (step 172). The Base Player module relays the pause instruction to the Base Player module, pausing it, the Base Player module then masks the main video 30 (step 174). Simultaneously with step 172, the Interstitial Video module begins playing one of the additional predefined video elements, and instructs it to play (step 176). Upon one of the interstitial videos ending, the Interstitial Video module makes one or more calls to the Base Player module to un-pause and un-mask the main video (step 178), and the Base Player module begins playing the paused main video (step 180).

### Reveal Box Module

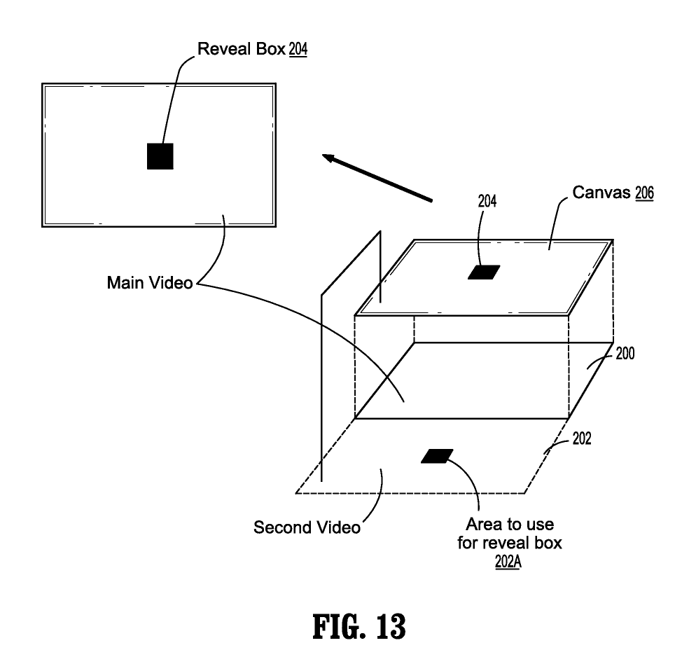

The Reveal Box module enables functionality by which a video playing in the platform may be overlaid with a “reveal box.” A reveal box is a small area drawn on the canvas in which additional video content is to be displayed over a video playing and visible in container 22. The Reveal Box module contains a masked video stack that is sized to be equal in width and height to the container 22. The exemplary masked video stack in FIG. 13 contains two videos, a main video 200 and a second video 202. The second video 202 is pushed outside of the visible area of the container 22, so that the main video 200 is visible to the user. If the masked video stack contains more than two videos, the main video would be visible to the user and the other videos would be pushed outside the boundary of the container 22. A transparent canvas 206 is then placed above the masked video stack. The canvas 206 is equal in height to the container's height, and the width of the canvas 206 can be adjusted between zero and the width of the container 22. In the exemplary embodiment of FIG. 13, a portion 202A of the second video 202 is used for the reveal box 204 that is rendered in the canvas 206, as will be described in more detail below.

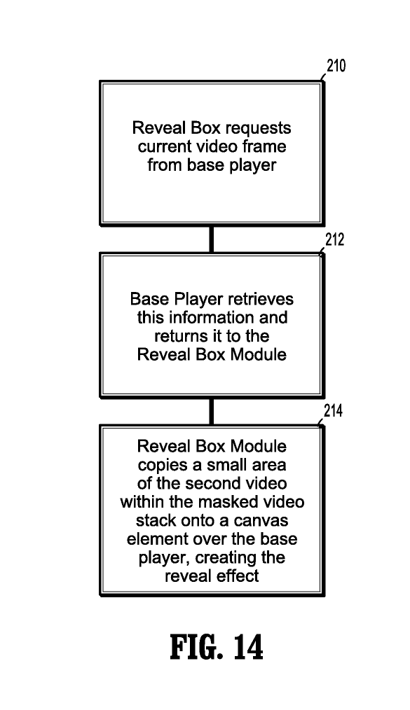

Referring to FIGS. 13 and 14, an example of the operation of the Reveal Box module will be described. The Reveal Box module is instantiated at the same time as the platform, i.e., upon a user loading the web page in which the platform is embedded. Once instantiated, the Reveal module is responsive to pre-defined trigger actions while a video, e.g., the main video 200, is playing. The trigger actions are pre-defined via a data file stored in the Reveal Box module or Base Player module, or the trigger actions can be installed at the platform level by an individual user. For example, the trigger actions can be the pressing one or more keys, e.g., the number 1, 2, and/or 3 keys, on keyboard. The masked video stack containing the two videos is presented to a user as one video via the same process described above with regards to the Split-screen module. The two videos differ visually by, for example, having been previously created so that the main video 200 is blurry, and the second video 202 is in focus. As is seen in FIG. 13, a majority of the canvas 206 is empty, but the pixel information defining portion 202A of the second video 202 is rendered onto the empty canvas 206 around the mouse (or cursor), to give the impression of a box seeing through the main (blurry) video, “revealing” a clear one underneath, i.e., revealing the focused pixel information of portion 202A from the secondary video 202.

Referring to FIG. 14, upon a trigger action, the reveal box module makes one or more calls at a small interval, such as 10 calls per second, to the Base Player module requesting access to pixel information from the current frame of the video file (step 210). In this example, the video files contains the main video 200 and the second video 202. The Base Player module retrieves the pixel information from the current frame of the video file, and returns the pixel information to the Reveal Box module (step 212). The Reveal Box module uses the pixel information to copy certain pixel information defining portion 202A of the second video 202 onto the transparent canvas 206 above the masked video stack (step 214). The portion of the canvas 206 which has the pixel information for portion 202A of the second video 202 is the only pixel information that overlays the main video 200 thus creating the “reveal box” effect. It is noted that if the reveal box effect is not desired at the moment a video begins playing within the platform, the visual elements that constitute the Reveal Box module's functionality can be hidden until a point in the video is reached when the reveal box should become visible.

### Zoom Box Module

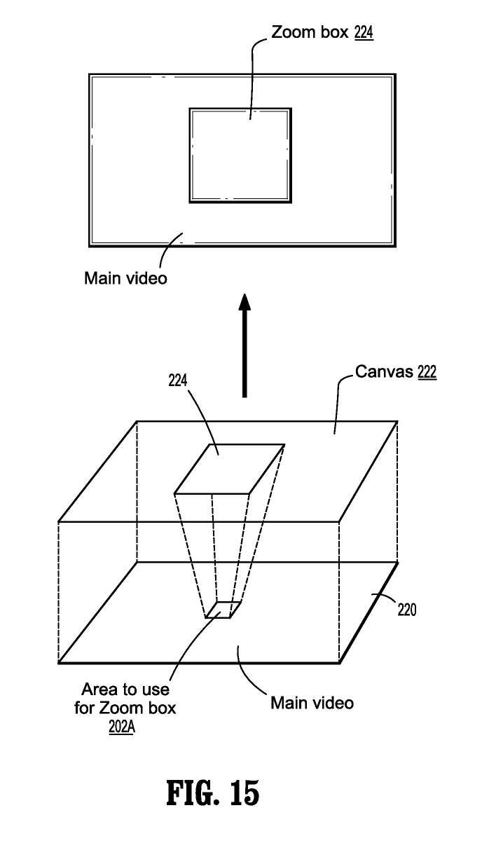

Referring to FIG. 15, the Zoom Box module enables functionality by which an area of a video playing within the platform may be zoomed in upon, and overlaid on itself, similar in concept to a magnifying glass over text on a sheet of paper. The Zoom Box module contains a masked video stack that is sized to be equal in width and height to the container 22. The exemplary masked video stack in FIG. 15 contains a single video, main video 220. A transparent canvas 222 is then placed above the masked video stack. The canvas 222 is equal in height to the container 22 height, and the width of the canvas 206 can be adjusted between zero and the width of the container 22. In the exemplary embodiment of FIG. 15, a portion 220A of the main video 220 is used for the zoom box 224 that is rendered in the canvas 222, as will be described in more detail below.

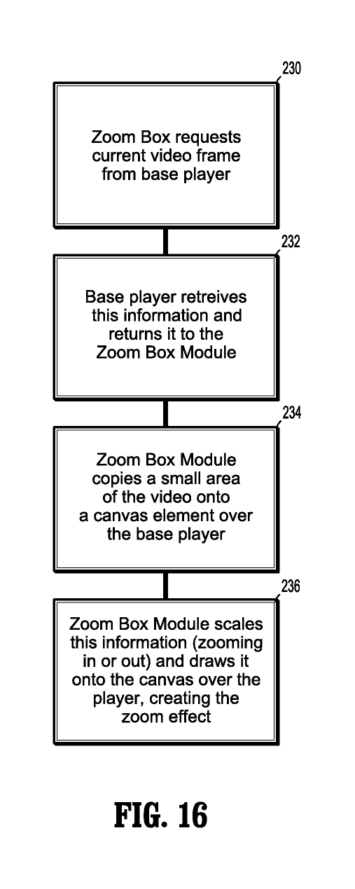

Referring to FIGS. 15 and 16, an example of the operation of the Zoom Box module will be described. The Zoom Box module is instantiated at the same time as the platform, i.e., upon a user loading the web page in which the platform is embedded. Once instantiated, the Zoom module is responsive to pre-defined trigger actions while a video, e.g., the main video 220, is playing. The trigger actions are pre-defined via a data file stored in the Zoom Box module or Base Player module, or the trigger actions can be installed at the platform level by an individual user. For example, the trigger actions can be the pressing one or more keys, e.g., the number 1, 2, and/or 3 keys, on keyboard.

Initially, a video file is loaded into the platform, and a canvas element 222 is created and resized to be equal in width and height to the main video 220 playing within the platform and visible via container 22. The transparent canvas element 222 is placed directly over the main video 220. The Zoom Box module then makes one or more calls at a small interval, such as 10 calls per second, to the Base Player module requesting access to pixel information from the current frame of the main video in the video file (step 230). The Base Player module retrieves the requested pixel information and returns the pixel information to the Zoom Box module (step 232). The Zoom Box module then reads pixel information provided by the Base Player module, and copies a portion of the pixel information, e.g. a 50 pixel radius from each side of the mouse (or cursor) (step 234). The Zoom Box module then scales the copied portion of the pixel information by either stretching or squeezing the pixel information, and then renders the scaled pixel information onto the transparent canvas 222 above the masked video stack (step 236). To scale the pixel information, the Zoom Box module uses a desired zoom factor (e.g., 150% zoom or 50% zoom) to determine what data to draw onto the canvas 222. Thus, the canvas 222 has the new scaled pixel information drawn upon it, centered at the mouse (or cursor) position creating the zoom effect. It is noted that if the zoom box effect is not desired at the moment a video begins playing within the platform, the visual elements which constitute the Zoom Box module's functionality can be hidden until a point in the video is reached when the zoom box should become visible.

### Dynamic Speed Module

The Dynamic Speed module enables functionality by which the playback rate of a video playing in the platform can be changed, either slowed or sped up, in response to a trigger action.

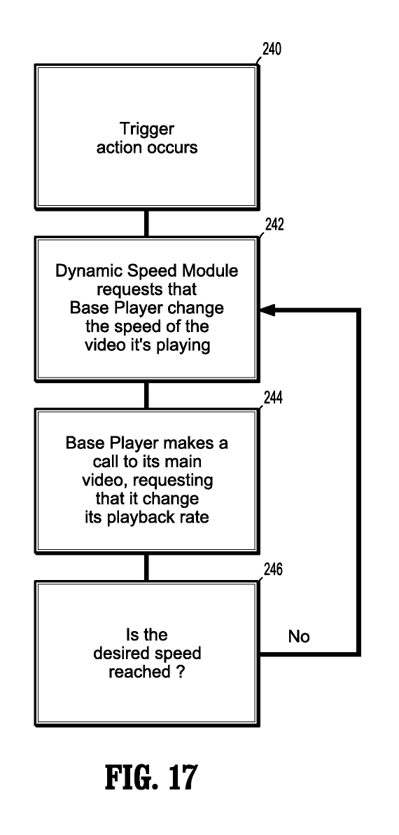

Referring to FIG. 17, an example of the operation of the Dynamic Speed Box module will be described. The Dynamic Speed module is instantiated at the same time as the platform, i.e., upon a user loading the web page in which the platform is embedded. Once instantiated, the Dynamic Speed module is responsive to pre-defined trigger actions while a video, e.g., the main video 30, is playing. The trigger actions are pre-defined via a data file stored in the Base Player module or the Dynamic Speed module, or the trigger actions can be installed at the platform level by individual users. For example, the trigger actions can be the pressing one or more keys, e.g., the number 1, 2, and/or 3 keys, on keyboard).

Once a trigger action, such as hovering the cursor over the video, is interpreted by the Dynamic Speed module, the module communicates with the platform's currently playing video, and directly manipulates the playback rate of the playing video, either speeding it up or slowing it down. Upon a canceling of the trigger action, such as removing the cursor from hovering over the video, the Dynamic Speed module communicates with the platform's currently playing video, and returns the playback speed of the video to its default or normal speed. The speed can be set instantly or ramped up or down slowly to achieve a desired effect. More specifically, upon a trigger action (step 240), the Dynamic Speed module makes a one or more calls to the Base Player module requesting that the Base Player module change the playback rate of the video playing within the platform (step 242). For example, a single call may be made to the Base Player module to instantly change the speed of the video playing in the platform to a new value or rate, or multiple calls may be made to the Base Player module that slowly brings the video speed to a desired value or rate (step 244). The Base Player module relays the one or more instructions, changing the speed of the video (step 244) until a desired speed is reached (step 246).

### Hotspot Module

The Hotspot module enables functionality by which actionable (or clickable) areas on the display (or screen), called hotspots, can be overlaid on a video being played within the platform at specific times, and performing any number of actions connected to the Base Player module or other modules within the platform.

An example of the operation of the Hotspot Box module will be described. The platform can be configured to have one or more cues set to display a hotspot at a set time, e.g., 3-10 seconds, into a video playing within the platform. In this example, when the video's playback time passes 3 seconds, the hotspot fades into view. This is achieved by relaying predefined actions to the Base Player module. If a user clicks the hotspot with the mouse, the action contained within the Hotspot is executed. Examples of hotspot actions include playing an interstitial video, turning on a split-screen effect, or linking out to other web sites. For static hotspots, the hotspots are confined to their position on screen, and fade out after their duration is exceeded. Thus, in the above example, after 10 seconds the hotspot would fade out. Dynamic hotspots are configured to have a position dependent on a time of the video, such that between any two points in time, there is an on-screen position which can be derived from interpolating between position and time values defined in a rider data file stored within the Base Player module or the Hotspot module, which when called for by the Hotspot module initiates a predefined action. Actions include, becoming a “clickable region, animation, sound, etc. For example, if a dynamic hotspot is defined in a rider data file to exist at position (100,100) at 5 seconds into the video and (200,200) at 10 seconds into the video, the hotspot's derived position would be at 7.5 seconds into the video and the position would be (150, 150). It is also possible to display hotspots only when the video playing within the platform is paused. It is also possible to have hotspots always invisible, though still clickable, that is to say that the action is not dependent on video play, but instead defined based on time relative to the full video (in milliseconds) and positioning (the height and width pixels) within the video. It is noted that if a hotspot is not desired at the moment a video begins playing within the platform, the visual elements which constitute the Hotspot module's functionality can be hidden until a point in the video is reached when the hot spot should become visible.

To provide more detail of the Hotspot module, each hotspot placed on the platform is an individual instance of the Hotspot module, which is loaded upon a user loading the web page which the platform player is embedded. Once instantiated, the Hotspot module is responsive to pre-defined trigger actions while a video, e.g., the main video 30, is playing. The trigger actions are pre-defined via a data file stored in the Hotspot module or Base Player module, or the trigger actions can be installed at the platform level by individual users. For example, the trigger actions can be a mouse click, or the pressing one or more keys, e.g., the number 1, 2, and/or 3 keys, on keyboard. Each hotspot has a dynamic action attribute which allows the Hotspot module to be used to trigger other functionality associated with the platform, such as enabling another module, changing the video source, and loading a new web page, along with a time range where the hotspot should be made visible within the video playing in the platform.

Each hotspot's dynamic action attribute is set so that when the hotspot becomes visible, the user may trigger its associated action by interacting with the hotspot. The hotspot makes calls at a small interval (for example, two calls per second) to the Base Player module requesting the current time of the video playing within the platform. The Base Player module retrieves the current time of the video playing information from the underlying video element, and relays it back to the Hotspot module. The Hotspot module checks if the time value returned by the Base Player module is within the range of time when it is supposed to be visible on the screen, by parsing predefined data points in the Hotspot module. If the hotspot is not visible, but the time value is within this range, the Hotspot module fades into view and becomes available for user interaction. If the hotspot is visible, but the time value is not within this range, the Hotspot module fades out of view and becomes unavailable for user interaction. If a hotspot is interacted with while visible, the Hotspot module performs its dynamic action.

### In-Platform Image and Video Filtering Module

The In-Platform Image and Video Filtering module enables functionality by which the platform's video output or images associated with the platform may be filtered to create visual effects which are seamlessly overlaid on the platform video output or images. Initially, a transparent canvas, e.g., canvas 103 shown in FIG. 7, is created which is equal in size (height and width) to the video or image being filtered. The original video frame or image is then drawn onto the canvas, creating a source of pixel information. The pixel information is modified using known filtering techniques, such as histogram manipulation, to filter the images and/or video (which define the style and effect of a given filter), and the modified pixel data is redrawn upon the canvas. The canvas is then aligned on top of the masked video stack currently in the platform, which masks the original content to be filtered and the filtered content drawn within the canvas becomes visible.

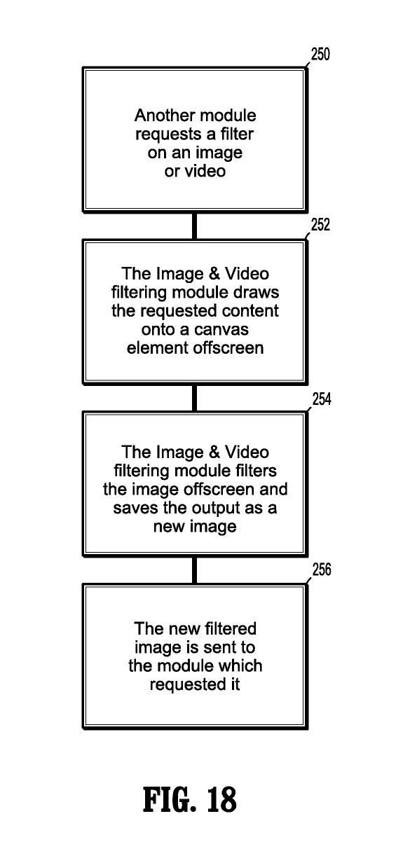

Referring to FIG. 18, more detail of the In-Platform Image & Video Filtering module process is provided. The In-Platform Image & Video Filtering module is instantiated at the same time as the platform, i.e., upon a user loading the web page in which the player is embedded. A canvas element is then created within the platform, but the canvas is not initially visible to the user, i.e., the canvas is initially transparent. When another module within the platform requests an image or video be filtered (step 250), such as the Interactive Video module requesting a picture from the Social Media module be turned black and white, that module, here the Interactive Video module, makes a call to the In-Platform Image & Video Filtering module with the resource (e.g., the video or image) to be filtered, and the filtering instructions (i.e., the mathematical formula for the desired filter). The In-Platform Image & Video Filtering module then draws the requested resource onto the canvas, which is invisible to the user (step 252). The resource's pixel data is then modified according to the filtering instructions provided by the other modules (step 254). Upon completion of the filtering process, the In-Platform Image & Video Filtering module returns the filtered image to the requesting module and clears the canvas used for drawing the requested resource, e.g., the requested image or video (step 256), to be displayed via the Base Player module.

Referring to FIG. 19, an exemplary network based computing environment is shown in which the platform according to the present disclosure may be a part of. In this exemplary embodiment the network computing environment may be the Internet (or web) or a cloud based computing environment. Alternatively, the network topology may be, for example, a local area network (LAN), a wide area network (WAN), a wireless wide area network, a circuit-switched telephone network, a Global System for Mobile Communications (GSM) network, Wireless Application Protocol (WAP) network, a WiFi network, an IEEE 802.11 standards network, and various combinations thereof. The network computing environment 300 includes one or more computing nodes 302, where the system according to the present disclosure would reside. Local (or client) computing devices used by users, such as, for example, personal digital assistants (PDA) or cellular telephones, desktop computers, laptop computers, and/or automobile computer systems may communicate with the system via network 300 and a local web browser. The nodes 302 may also communicate with one another. They may be grouped (not shown) physically or virtually, in one or more networks, such as Private, Community, Public, or Hybrid networks and cloud computing environments, or a combination thereof. This allows the network computing environment 300 to offer infrastructure, platforms and/or software for which users do not need to maintain resources on a local computing device, except for a tool to communicate to the network such as a web browser. It is understood that the types of user computing devices shown in FIG. 19 are intended to be illustrative and that computing nodes 302 and network computing environment 300 can communicate with any type of computerized device over any type of network and/or network addressable connection using, for example, a web browser.

Referring to FIG. 20, a block diagram of an exemplary embodiment of a computing environment 310 for running the platform is shown. In this exemplary embodiment, the computing environment 310 is interconnected via a bus 312. The computing environment 310 includes a processor 314 that executes software instructions or code stored on, for example, a computer readable storage medium 316 or stored in system memory 318, e.g., random access memory, or storage device 320, to perform the processes of the platform disclosed herein. The processor 314 can include a plurality of cores. The computing environment 310 of FIG. 20 may also include a media reader 322 to read the instructions from the computer readable storage medium 316 and store the instructions in storage device 320 or in system memory 318. The storage device 320 provides storage space for retaining static data, such as program instructions that could be stored for later execution. Alternately, with in-memory computing devices or systems or in other instances, the system memory 318 would have sufficient storage capacity to store much if not all of the data and program instructions used for the system, instead of storing the data and program instructions in the storage device 320. Further, the stored instructions may be further compiled to generate other representations of the instructions and dynamically stored in the system memory 318. In either embodiment, the processor 314 reads instructions from the storage device 320 or system memory 318, and performs actions as instructed.

The computing environment 310 may also include an output device 324, such as a display, to provide visual information to users, and an input device 326 to permit certain users or other devices to enter data into and/or otherwise interact with the computing environment 310. One or more of the output or input devices could be joined by one or more additional peripheral devices to further expand the capabilities of the computing environment 310, as is known in the art.

A communication interface 328 is provided to connect the computing environment 310 to the network 300 and in turn to other devices connected to the network 300, including clients, servers, data stores, and interfaces. A data source interface 330 provides access to data source 332, typically via one or more abstraction layers, such as a semantic layer, implemented in hardware or software. For example, the data source 332 may be accessed by user computing devices via network 300. The data source may include databases, such as, relational, transactional, hierarchical, multi-dimensional (e.g., OLAP) databases, object oriented databases, and the like. Further data sources may include tabular data (e.g., spreadsheets, and delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC) and the like. The data source can store spatial data used by the real estate data management system of the present disclosure.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including the HTML, an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the invention has been shown, described and illustrated in detail with reference to the preferred embodiments and modifications thereof, it should be understood by those skilled in the art that equivalent changes in form, materials and detail may be made therein without departing from the true spirit and scope of the invention as claimed below.

What is claims is:

1. A web based interactive multimedia platform to provide web based commercial activity, and including a processor and a memory, the memory comprising instructions that are executable by the processor, the web based interactive multimedia platform comprising:
a core structure that facilitates the playing of video within the platform on a web browser page, and that facilitates the displaying other media within the platform on a web browser page platform, the core structure is to be embedded within the code base of a web browser having built-in multimedia processes; and
one or more modules installed on top of the core structure and interconnected to each other and the core structure via a common interface, the one or more modules provide additional functionality, interactivity, and/or shoppability to enhance user experience provided on the web browser page.

2. The web based interactive multimedia platform according to claim 1, wherein the one or more modules comprises a controls module that enables the core structure to display user activated controls over the video while the video is playing.

3. The web based interactive multimedia platform according to claim 2, wherein the user activated controls include a play/pause button, a volume control slide, a mute button, and a multi-section time bar.

4. The web based interactive multimedia platform according to claim 1, wherein the one or more modules comprises a carousel module that enables the core structure to display a moving carousel of objects in a predefined position relative to the video playing.

5. The web based interactive multimedia platform according to claim 4, wherein each object in the carousel of objects is a consumer product.

6. The web based interactive multimedia platform according to claim 1, wherein the one or more modules comprises a dynamic speed module that that enables the core structure to change the playback rate of a video playing in response to a trigger action.

7. The web based interactive multimedia platform according to claim 1, wherein the one or more modules comprises a split-screen module that enables the core structure to create an interactive “split-screen” effect over a video playing in response to a trigger action.

8. The web based interactive multimedia platform according to claim 1, wherein the one or more modules comprises a multiple cameras module that enables a user to select one of multiple camera angles of the same subject in a video playing and that enables the core structure to switch the video playing to the selected camera angle.

9. The web based interactive multimedia platform according to claim 1, wherein the one or more modules comprises a multiple grades module enables the core structure to display any one of multiple color grades of a video playing in response to a trigger action.

10. The web based interactive multimedia platform according to claim 1, wherein the one or more modules comprises an interactive module comprising multiple videos and that is responsive to user trigger action that permits the user to initiate a choose-your-own-adventure, such that when the core structure stops playing one video of the multiple videos the user can then select another video of the multiple videos for the core structure to play.

11. The web based interactive multimedia platform according to claim 1, wherein the one or more modules comprises a reveal box module that overlays video content as a reveal box over a video playing.

12. The web based interactive multimedia platform according to claim 1, wherein the one or more modules comprises an interstitial video module that upon a trigger action may cause the core structure to pause the video playing and cause the core structure to play one or more interstitial videos.

13. The web based interactive multimedia platform according to claim 1, wherein the one or more modules comprises an in-platform image and video filtering module that filters a video playing in the system to create visual effects which are seamlessly overlaid on the video playing.

14. The web based interactive multimedia platform according to claim 1, wherein the one or more modules comprises a zoom box module, where upon a trigger action the zoom box module selects an area of a video playing for a zoom effect and then causes the causes the core structure to display the zoomed in area.

15. An article of manufacture including a tangible machine readable medium having instructions which when executed by a machine cause the machine to perform a method to execute a web based interactive multimedia platform to provide web based commercial activity, the method comprising:
providing a core structure that facilitates the playing of video and audio within a web browser page, and that facilitates the displaying other media within the web browser page platform;
embedding the core structure within the code base of the web browser page, wherein the web browser has built-in multimedia processes; and
embedding one or more modules on top of the core structure code base, wherein the one or more modules provide additional functionality, interactivity, and/or shoppability to enhance user experience provided on the web browser page; and
instantiating the core structure and one or more modules to launch the platform and initiate an interactive and user shopping experience on the web browser page.

16. A computer implemented method to execute a web based interactive multimedia platform to provide web based commercial activity, the method comprising:
providing a core structure that facilitates the playing of video and audio within a web browser page, and that facilitates the displaying other media within the web browser page platform;
embedding the core structure within the code base of the web browser page, wherein the web browser has built-in multimedia processes; and
embedding one or more modules on top of the core structure code base, wherein the one or more modules provide additional functionality, interactivity, and/or shoppability to enhance user experience provided on the web browser page; and
instantiating the core structure and one or more modules to launch the platform and initiate an interactive and user shopping experience on the web browser page.
